(19) United States
(12) Patent Application Publication
(10) Pub. No.: US 2024/0320585 A1
(43) Pub. Date: Sep. 26, 2024

(54) TASK PROCESS ANALYSIS METHOD

(71) Applicant: NoriSpace Co., Ltd., Seoul (KR)

(72) Inventors: Hyun Joon SHIN, Seoul (KR); Ho Geun KWON, Seoul (KR)

(73) Assignee: NoriSpace Co., Ltd., Seoul (KR)

(21) Appl. No.: 18/734,154

(22) Filed: Jun. 5, 2024

Related U.S. Application Data
(63) Continuation of application No. PCT/KR2022/017430, filed on Nov. 8, 2022.

(30) Foreign Application Priority Data
Dec. 6, 2021 (KR) 10-2021-0173317
Jun. 13, 2022 (KR) 10-2022-0071613

(51) Int. Cl. G06Q 10/0631; G06Q 10/0633

(52) U.S. Cl. CPC G06Q 10/06316; G06Q 10/06315; G06Q 10/0633

(57) ABSTRACT

According to an embodiment of the present disclosure, there may be provided a task process analysis method, the method of collecting work history data of an individual or a group to predict a next task that should be performed after a certain task when the individual or the group performs the certain task, and obtaining prediction data about the next task by inputting the collected work history data into a natural language processing model.

### CROSS REFERENCE TO RELATED APPLICATION

The present application is a continuation of International Patent Application No. PCT/KR2022/017430, filed on Nov. 8, 2022, which claims priority to Korean Patent Application No. 10-2021-0173317, filed on Dec. 6, 2021 and Korean Patent Application No. 10-2022-0071613, filed on Jun. 13, 2022 the entire contents of which are incorporated herein for all purposes by this reference.

### BACKGROUND

### Technical Field

The present disclosure relates to a method of analyzing a task process and, in more detail, a method of predicting a task that should be performed later on the basis of a specific task by analyzing a process of conducting a task by an individual or a group.

### Description of the Related Art

Recently, studies on technologies of improving the task efficiency of individuals or automate a task process (Robotic Process Automation, RPA), and process mining or data logging for them are being actively conducted with development of the AI technology.

Meanwhile, such studies do consider the not correlation between tasks while having a specific task of the entire task as an analysis target. Accordingly, a method of predicting a task that should be performed after a specific task in the entire task process and, in addition, a method of automating the entire task process have a limitation that they cannot be implemented by existing studies or technologies.

Accordingly, in order to improve or automate the entire task process, it is required to expand an analysis target task to not only a specific task, but the entire task process and there is a need for a task process analysis method considering the expanded analysis target.

### SUMMARY

An objective to be achieved in the present disclosure is to provide a method of collecting a work history of an entire task performed by an individual to analyze a task process.

An objective to be achieved in the present disclosure is to provide a method of converting collected work history data into data suitable for analysis before analyzing a task process.

An objective to be achieved in the present disclosure is to provide a method of predicting a task that should be performed after a reference task by analyzing a task process.

An objective to be achieved in the present disclosure is to provide a method of examining result data obtained through task process analysis.

Objectives of the present disclosure are not limited to those described above and objectives not stated above will be clearly understood to those skilled in the art from the specification and the accompanying drawings.

According to an embodiment of the present disclosure, there may be provided a task prediction method that is performed in an electronic device of a user, the task prediction method including: obtaining work history data according to use of the electronic device of the user—the work history data including a plurality of log data and a plurality of image data; obtaining reference task data using the work history data—the reference task data including at least one sequence data and the sequence data being created using at least some of the plurality of log data and at least some of the plurality of image data; and obtaining prediction task data using the reference task data and a task prediction module, wherein the task prediction module includes an encoder that outputs intermediate data by receiving the reference task data, and a decoder that obtains the intermediate data from the encoder and outputs data using the intermediate data, wherein the encoder includes neural networks of the number corresponding to the number of sequence data included in the reference task data.

According to another embodiment of the present disclosure, there may be provided a task flow analysis model that is stored in a computer-readable recording medium, the task flow analysis model including: a work history collection module that obtains work history data corresponding to work performed through the electronic device—the work history data including a plurality of log data and a plurality of image data; a preprocessing module that obtains reference task data by processing the work history data—the reference task data including at least one sequence data and the sequence data being created using at least some of the plurality of log data and at least some of the plurality of image data; and a task prediction module that obtains prediction task data using at least the reference task data, wherein the task prediction module includes an encoder that outputs intermediate data by receiving the reference task data, and a decoder that obtains the intermediate data from the encoder and outputs data using the intermediate data, wherein the encoder includes neural networks of the number corresponding to the number of sequence data included in the reference task data.

According to another embodiment of the present disclosure, there may be provided an electronic device-readable task flow analysis model, the task flow analysis model including: a work history collection module that obtains work history data corresponding to work performed through the electronic device—the work history data including a plurality of log data and a plurality of image data; a preprocessing module that obtains reference task data by processing the work history data—the reference task data including at least one sequence data and the sequence data being created using at least some of the plurality of log data and at least some of the plurality of image data; and a task prediction module that obtains prediction task data using at least the reference task data, wherein the task prediction module includes an encoder that outputs intermediate data by receiving the reference task data, and a decoder that obtains the intermediate data from the encoder and outputs data using the intermediate data, wherein the encoder includes neural networks of the number corresponding to the number of sequence data included in the reference task data.

Objectives of the present disclosure are not limited to those described above and objectives not stated above will be clearly understood to those skilled in the art from the specification and the accompanying drawings.

According to an embodiment of the present disclosure, work histories about a task performed by an individual is selectively collected and data for task process analysis is additionally secured for a specific task history, whereby a more accurate task process analysis result can be obtained.

According to an embodiment of the present disclosure, it is possible to use an artificial neural network model having sequences as input and output by classifying collected work history data into sequences.

According to an embodiment of the present disclosure, it is possible to increase completeness of a task prediction result by examining a task prediction result through task process analysis.

Effects of the present disclosure are not limited to those described above and effects not stated above will be clearly understood to those skilled in the art from the specification and the accompanying drawings.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a diagram showing a process in which a task process analysis model according to an embodiment of the present disclosure is used;

FIG. 2 is a diagram showing the components of the task process analysis model according to an embodiment of the present disclosure;

FIG. 3 is a diagram showing the function of each of the components of the task process analysis model according to an embodiment of the present disclosure;

FIG. 4 is a diagram showing a task process analysis method according to an embodiment of the present disclosure;

FIG. 5 to FIG. 9 are diagrams showing a process of collecting work history data according to an embodiment of the present disclosure;

FIG. 10 is a diagram showing a process of classifying work history data according to an embodiment of the present disclosure;

FIG. 11 is a diagram showing a process in which the form of work history data according to an embodiment of the present disclosure is converted;

FIG. 12 and FIG. 13 are diagrams showing the structure of a task prediction module according to an embodiment of the present disclosure;

FIG. 14 is a diagram showing examination that is performed by an examination module according to an embodiment of the present disclosure; and

FIG. 15 is a diagram showing a training method for a task prediction module according to an embodiment of the present disclosure.

### DETAILED DESCRIPTION

According to an embodiment of the present disclosure, there may be provided a task prediction method that is performed in an electronic device of a user, the task prediction method including: obtaining work history data according to use of the electronic device of the user—the work history data including a plurality of log data and a plurality of image data; obtaining reference task data using the work history data—the reference task data including at least one sequence data and the sequence data being created using at least some of the plurality of log data and at least some of the plurality of image data; and obtaining prediction task data using the reference task data and a task prediction module, wherein the task prediction module includes an encoder that outputs intermediate data by receiving the reference task data, and a decoder that obtains the intermediate data from the encoder and outputs data using the intermediate data, wherein the encoder includes neural networks of the number corresponding to the number of sequence data included in the reference task data.

In this configuration, the plurality of log data may be classified as event log data corresponding to execution of application programs stored at least in the electronic device or action log data corresponding to specific function performance in the application programs.

Further, the plurality of image data may be classified as action image data relating to at least the specific function performance or screen image data relating to the specific function performance, the action image data may be data relating to at least some of images that are output through the screen of the electronic device, the screen image data may be data relating to at least some of images that are output through the screen of the electronic device, and the size of an image corresponding to the screen image data may be larger than the size of an image corresponding to the action image data.

Further, the obtaining of reference task data may include: classifying the plurality of log data and the plurality of image data at least into a task group or a non-task group; and creating the at least one sequence data using log data and image data classified as the task group.

Further, the obtaining of reference task data may include creating the sequence data by classifying the plurality of log data and the plurality of image data on the basis of at least one event log data, wherein the event log data that is one of the plurality of log data may correspond to execution or end of an application program stored in the electronic device.

Further, the sequence data may include at least one log vector data obtained by processing at least some of the plurality of log data and at least one image vector data obtained by processing at least some of the plurality of image data.

Further, the obtaining of reference task data may include: obtaining at least one tokenized log data by tokenizing at least some of the plurality of log data; and obtaining log vector data by embedding the tokenized log data.

Further, the task prediction module may be a sequence-to-sequence module and the intermediate data may be vector data obtained from the at least one sequence data of the reference task data.

Further, the neural network may be a recurrent neural network model.

Further, the neural network model may be a Long-Short Term Memory (LSTM) model.

Further, the obtaining of prediction task data may include: creating at least one prediction sequence data by inputting the intermediate data and start data into the decoder; and creating the prediction task data using the at least one prediction sequence data, wherein the prediction sequence data may include at least one prediction log data.

Further, the task prediction method may further include examining the prediction task data.

Further, the prediction task data may include at least one primary prediction sequence data—the primary prediction sequence data including at least one prediction log data, and the examining of prediction task data may include comparing the at least one prediction log data of the primary prediction sequence data with at least one certain log data.

Further, the comparing of the at least one prediction log data with at least one certain log data may include calculating similarity between the at least one prediction log data with the at least one certain log data using a Dynamic Time Warping (DTW) algorithm.

Further, the task prediction method may include: creating at least one secondary prediction sequence data using the task prediction module when the similarity is a preset effective threshold or less; or creating prediction task data validated using the at least one primary prediction sequence data when the similarity is a preset effective threshold or more.

Further, the at least one certain log data may be a portion of the plurality of log data.

Further, the method may further include displaying information about the next task, which should be performed after a task corresponding to the reference task data, on the electronic device on the basis of the prediction task data.

According to another embodiment of the present disclosure, there may be provided a task flow analysis model that is stored in a computer-readable recording medium, the task flow analysis model including: a work history collection module that obtains work history data corresponding to work performed through the electronic device—the work history data including a plurality of log data and a plurality of image data; a preprocessing module that obtains reference task data by processing the work history data—the reference task data including at least one sequence data and the sequence data being created using at least some of the plurality of log data and at least some of the plurality of image data; and a task prediction module that obtains prediction task data using at least the reference task data, wherein the task prediction module includes an encoder that outputs intermediate data by receiving the reference task data, and a decoder that obtains the intermediate data from the encoder and outputs data using the intermediate data, wherein the encoder includes neural networks of the number corresponding to the number of sequence data included in the reference task data. According to another embodiment of the present disclosure, there may be provided an electronic device-readable task flow analysis model, the task flow analysis model including: a work history collection module that obtains work history data corresponding to work performed through the electronic device—the work history data including a plurality of log data and a plurality of image data; a preprocessing module that obtains reference task data by processing the work history data—the reference task data including at least one sequence data and the sequence data being created using at least some of the plurality of log data and at least some of the plurality of image data; and a task prediction module that obtains prediction task data using at least the reference task data, wherein the task prediction module includes an encoder that outputs intermediate data by receiving the reference task data, and a decoder that obtains the intermediate data from the encoder and outputs data using the intermediate data, wherein the encoder includes neural networks of the number corresponding to the number of sequence data included in the reference task data.

The objectives, features, and advantages of the present disclosure will be made clearer through the following detailed description related to the accompanying drawings. The present disclosure may be modified in various ways and implemented by various exemplary embodiments, so that specific exemplary embodiments are shown in the drawings and will be described in detail hereafter.

Like reference numerals fundamentally indicate the same components throughout the specification. Components having the same functions within the same scopes in drawings of embodiments are described with the same reference numerals, and repeated description thereof is omitted.

Numbers (e.g., first, second, etc.) used in the description of the present disclosure are only identification symbols to discriminate one component from another component.

Terms “module” and “unit” that are used for components in the following embodiments are used only for the convenience of description without having discriminate meanings or functions.

In the following embodiments, singular forms are intended to include plural forms unless the context clearly indicates otherwise.

In the following embodiments, terms such as “include” or “have” mean that the features or components described herein exist without excluding the possibility that one or more other features or components are added.

When an embodiment can be implemented in another way, specific processes may be performed in order different from the description. For example, two sequentially described processes may be substantially simultaneously performed or may be performed in the reverse order of the described order.

In the following embodiments, when films, regions, components are connected, it includes not only the case in which the films, the regions, and the components are directly connected, but the case in which the films, the regions, and the components are indirectly connected with other films, regions, and components therebetween.

For example, in the specification, when films, regions, and components are electrically connected, it includes not only the case in which the films, regions, and components are directly electrically connected, but the case in which the films, regions, and components are indirectly electrically connected with another film, region, and component therebetween.

The present disclosure relates to a method of analyzing a task process and, in more detail, a method of collecting work history data in a process of conducting a task by an individual or a group and of predicting a task that should be performed later on the basis of a specific task by analyzing the collected work history data.

In the present disclosure, a ‘task’ may mean work that is performed by an individual or a group (hereafter, ‘an individual, or the like’) at a workplace, etc. In detail, the task may mean office work that is performed by an individual, or the like using electronic devices at a workplace, etc. For example, the task may mean a process in which electronic devices such as a computer, a tablet, or a mobile phone are used, particularly, a series of processes in which application programs in an electronic device are executed and various functions are implemented in the executed application programs. Alternatively, the task may mean a part at which data can be collected in office work that is performed by an individual, or the like. For example, when any action of an individual, or the like who is working is collected as work history data, the action can be considered as a task. Meanwhile, the task does not necessarily mean work that is performed at a workplace and may include also a profit-making or nonprofit-making action by an individual, or the like.

In the specification, the ‘work history’ may be understood as a record of a process of performing a task by an individual, or the like. For example, when an individual, or the like performs specific work through an electronic device, a work history may include logs that are stored in the electronic device or images, videos, or the like that can be additionally collected through the electronic device. Work history data means data relating to the work history described above and the details will be described below.

### [Task Process Analysis Model]

Hereafter, a task process analysis model is described with reference to FIG. 1 to FIG. 3.

FIG. 1 is a diagram showing a process in which a task process analysis model 1000 according to an embodiment of the present disclosure is used.

Referring to FIG. 1, the task process analysis model 1000 can obtain information about pieces of work that are performed in a process in which an individual, or the like conducts a task, and can perform proposal of a next task, automation of a task process, or proposal of a plan for improving a task process using the obtained information.

For example, the task process analysis model 1000 can propose a next task. The task process analysis model 1000 can propose a task that should be performed after a specific task when an individual, or the like performed the specific task. In detail, when an entire task includes a task A, a task B, and a task C that should be sequentially conducted and when an individual, or the like is conducting or finished the task A, the task process analysis model 1000 can propose conducting the task B, or the task B and the task C as the next task.

As another example, the task process analysis model 1000 can automate at least a portion of a task process. The task process analysis model 1000 can detect fields that can be automated from a task process by analyzing tasks performed by an individual, or the like, and can conduct pieces of work of the detected fields without intervention of an individual, or the like.

As another example, the task process analysis model 1000 can propose a plan for improving a task process. The task process analysis model 1000 can propose parts at which a task conduct speed needs to be improved by measuring a task conduct speed by monitoring the process of performing a task by an individual, or the like.

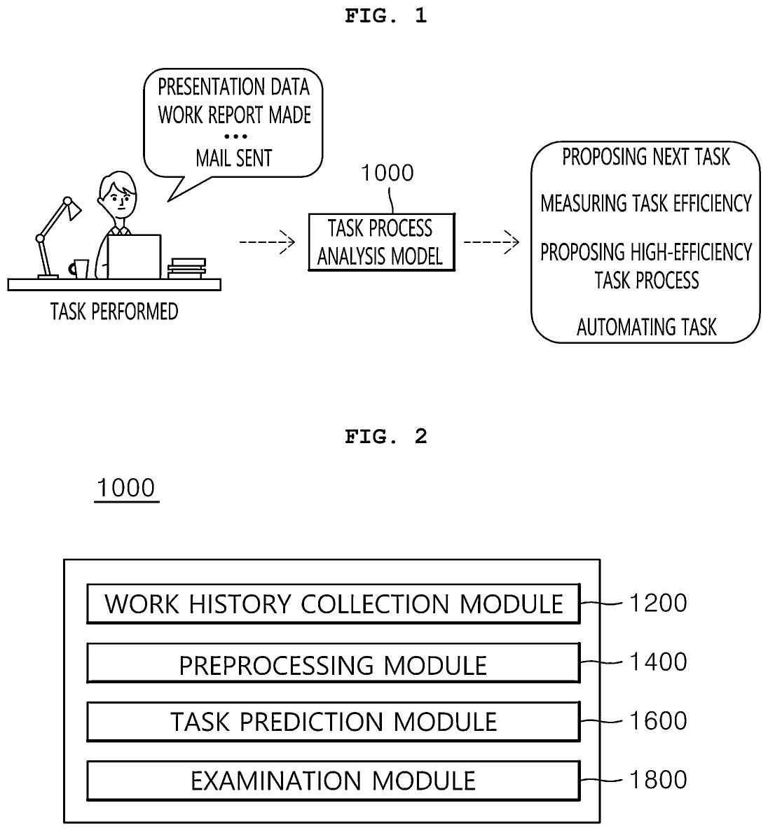

The task process analysis model 1000 may be understood as a program that is executed in an electronic device. The task process analysis model 1000 may include many modules or programs that perform specific functions, as shown in FIG. 2. The task process analysis model 1000 can be stored in any one computer-readable recording medium (hereafter, a ‘recording medium’) or an electronic device or divisionally stored in a plurality of recording media or electronic devices. For example, the task process analysis model 1000 may be stored in the memory unit of an electronic device, which an individual, or the like uses to perform a task, and may be implemented in a program type that is executed by a controller of the electronic device. As another example, a portion of the task process analysis model 1000 may be stored in an electronic device that is used for performing a task and the other may be stored in an external server, the portion of the task process analysis model 1000 stored in the external server may derive a task prediction result by analyzing work history data received from the electronic device, and the derived task prediction result may be provided to the electronic device.

The task process analysis model 1000 may be provided in a state in which it is stored in a recording medium or may be provided to be downloaded through an electronic device that an individual, or the like uses in a state in which it is stored in a server.

### [Configuration of Task Process Analysis Model]

FIG. 2 is a diagram showing the configuration of the task process analysis model 1000 according to an embodiment of the present disclosure.

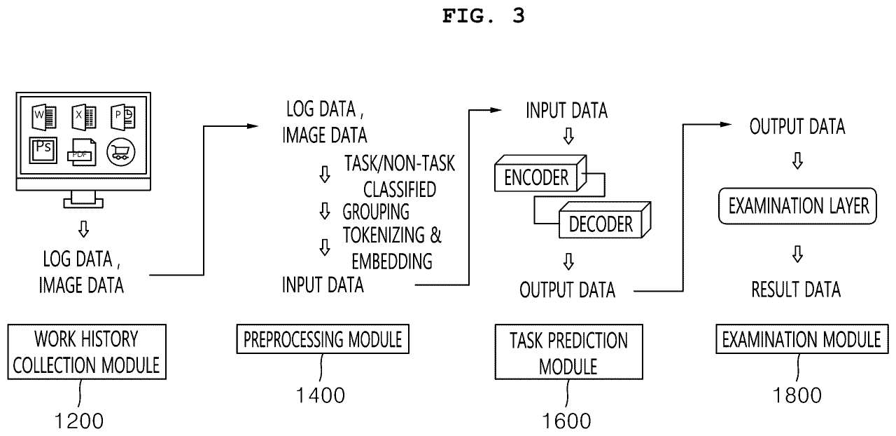

FIG. 3 is a diagram showing the function of each of the components of the task process analysis model 1000 according to an embodiment of the present disclosure.

Referring to FIG. 2, the task process analysis model 1000 may include a work history collection module 1200, a preprocessing module 1400, a task prediction module 1600, and an examination module 1800. The modules included in the task process analysis model 1000 may be provided as programs that perform different functions, and the modules may be divisionally stored in different recording media, servers, or the like or may be stored together in one recording medium or server.

Referring to FIG. 3, the work history collection module 1200 can collect work history data that is created in accordance performance of a task by an individual, or the like. In this case, the work history data is data that is created through an electronic device that is used to perform a task, and may include log data and image data.

Log data may be classified as event log data or action log data, depending the electronic device of an individual, or the like.

Event log data may include data about application program logs storing various events (e.g., execution, switch, end, etc.) recorded by application programs, security logs recording events relating to use of resources such as effective or ineffective attempts at log-on and creating, opening, deleting, etc. of files, and system logs that system components installed in an electronic device record, etc. Event log data may include data bout a console log, a mail log, a cron log, a boot log, a message log, etc. in accordance with the operating system installed in an electronic device.

Action log data may mean data that is created in the work progress process by an individual, or the like. For example, action log data may mean data about actions of an input device such as a keyboard or a mouse when an electronic device is used. In detail, action log data may mean log data about actions such as tap, left click, right click, double click, drag, and scroll of a mouse or keyboard input.

Image data may mean image data about any one moment in a task conduct process by an individual, or the like. For example, image data may be data relating to a screen that is output on an electronic device that is used to perform a task. The image data may be classified into screen image data and action image data. Screen image data and the action image data will be describe in detail below.

Image data can be obtained in the middle of conduct of a task by an individual, or the like through an electronic device. Image data can be obtained together with log data. For example, image data can be obtained when action log data of log data is created or obtained. In detail, image data can be obtained not only when a mouse is operated such as clicking, dragging, and moving a cursor, but when specific key input (e.g., shift, enter, tab, etc.) is generated Meanwhile, image data may be obtained together when the data is created or obtained as an event. Image data can be understood as data obtained additionally to log data for task process analysis.

The work history collection module 1200 can provide work history data to the preprocessing module 1400.

The preprocessing module 1400 can process the work history data obtained from the work history collection module 1200. For example, referring to FIG. 3, the preprocessing module 1400 can create input data by processing work history data, and in this process, work such as task/non-task classification, grouping, tokenizing & embedding, etc. can be performed.

The main function of preprocessing that is performed by the preprocessing module 1400 can be understood as classifying work history data in accordance with specific references except for unimportant parts of collected work history data, and making work history data into data of a specific form (e.g., the form of a natural language) in consideration of the task prediction module 1600 specified for specific data analysis (e.g., natural language analysis). The preprocessing will be described in detail below.

The preprocessing module 1400 can provide the created input data to the task prediction module 1600.

The task prediction module 1600 can create output data using the input data obtained from the preprocessing module 1400.

Input data can be understood as data corresponding to a reference task (or a current task) of the entire task process. In detail, input data can be obtained from work history data that is collected as an individual, or the like performs a reference task of the entire task process for a predetermined time period, and, in this case, the input data may be data about the reference task of the entire task process.

Output data can be understood as data corresponding to the next task that should be performed after a reference task of the entire task process. In detail, when input data is data corresponding to a reference task performed for a predetermined first time period, output data may correspond to the next task that should be performed for a second time period after the first time period. In this case, the first time period and the second time period may partially overlap each other.

The task prediction module 1600 may be implemented as an artificial neural network. For example, the task prediction module 1600 may be implemented as a sequence-to-sequence-to-sequence model using an sequence model, a attention model, a transformer model, a Bidirectional Encoder Representations from Transformers (BERT) model, of the like. In detail, referring to FIG. 3, the task prediction module 1600 may include an encoder that obtains a feature vector from input data and a decoder that creates output data using a feature vector. The structure and the algorithm of the task prediction module 1600 will be described below.

The task prediction module 1600 can provide the created output data to the examination module 1800.

As described above, the task process analysis model 1000 may be considered as a new and innovative model that analyzes a task process using a natural language processing model in that the task prediction module 1600 uses a neural network model that is usually used for natural language processing (NLP) such as voice recognition, machine translation, Q&A, or sentence creation and the preprocessing module 1400 converts work history data accompanying task performance into a natural language type.

The examination module 1800 can create result data using the output data obtained from the task prediction module 1600. The examination module 1800 may include an examination layer for examining output data. The examination module 1800 can examine whether output data is data showing a task. For example, the examination module 1800 can examine whether output data is data showing a task by comparing the output data with sample data showing a task. The structure and the algorithm of the examination module 1800 will be described below.

The examination module 1800 can examine output data and then create result data in accordance with the examination result. For example, when determining that output data is data showing a task, the examination module 1800 can output the output data as result data. As another example, when the output data is not determined as data showing a task, the examination module 1800 can request the task prediction module 1600 to create output data again and can examine the output data created again.

Since the task process analysis model 1000 includes examination the module 1800, the completeness or reliability of task prediction data that is finally created by the task process analysis model 1000.

### [Task Process Analysis Method]

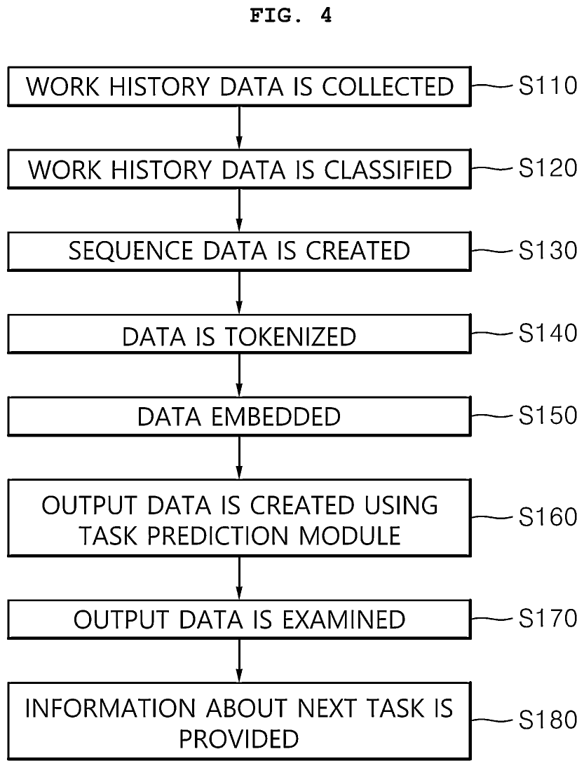

Hereafter, a task process analysis method is described with reference to FIG. 4 to FIG. 14.

FIG. 4 is a diagram showing a task process analysis method according to an embodiment of the present disclosure. Referring to FIG. 4 a task process analysis method may include collecting work history data (S110), classifying the work history data (S120), creating sequence data (S130), tokenizing data (S140), embedding data (S150), creating output data using a task prediction module 1600 (S160), examining the output data (S170), and providing information about the next task (S180).

Hereafter, these steps are described in detail.

### [Collection of Work History Data]

In task process analysis, the task process analysis model 1000 can collect work history data (S110). The work history collection module 1200 can collect log data and image data in a task conduct process by an individual, or the like.

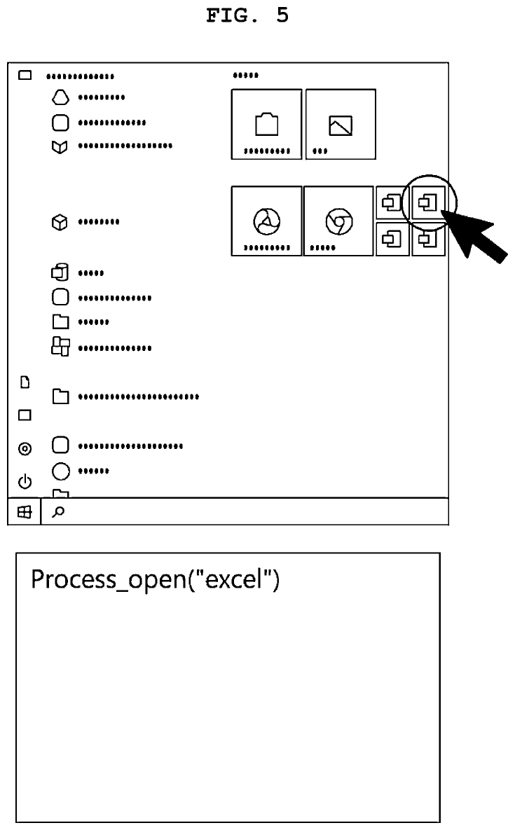

FIG. 5 to FIG. 9 are diagrams showing a process of collecting work history data according to an embodiment of the present disclosure.

Referring to FIG. 5, when an application program is executed in an electronic device, the work history collection module 1200 can obtain event log data about the application program. For example, the event log data may be ‘Process_open (“application program name”)’. When an application program is ended, similarly, the work history collection module 1200 can obtain event log data (e.g., Process_open (“application program name)) about the application program.

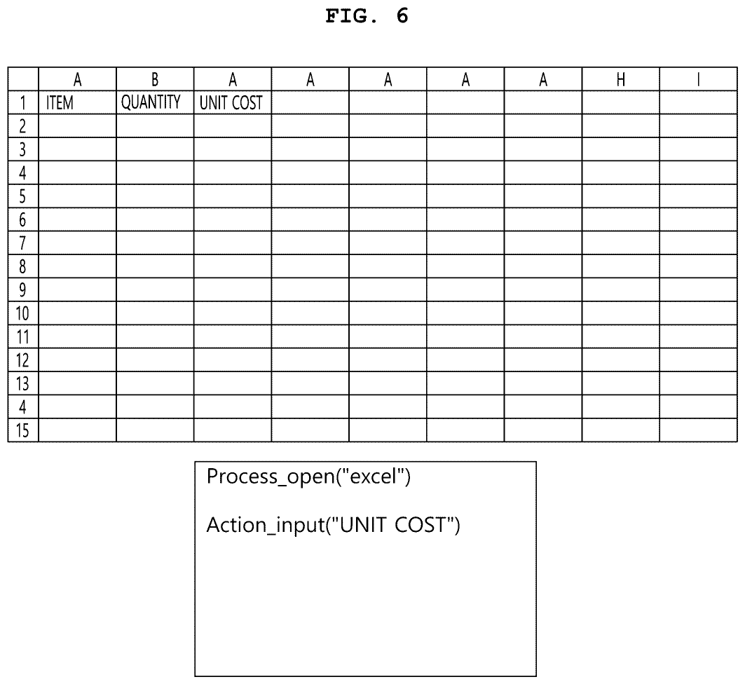

Referring to FIG. 6, when a specific action is performed while an application program is executed in an electronic device, the work history collection module 1200 can obtain action log data. For example, action log data that is collected when an individual, or the like types a specific word an in application program may be ‘Action_input (“the typed matter”)’.

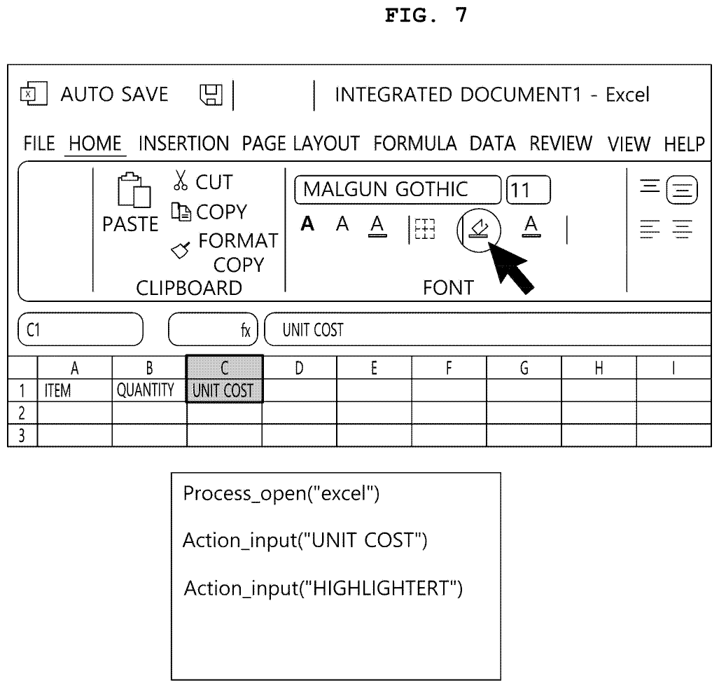

Referring to FIG. 7, when a specific function is performed while an application program is executed in an electronic device, the work history collection module 1200 can obtain action log data. For example, action log data that is collected when an individual, or the like performs a specific function by clicking an icon, etc. in an application program may be ‘Action click (“specific function”)’ or ‘Action click (“coordinates”)’.

Though not shown in FIG. 6 and FIG. 7, even when there is an action such as mouse click, double click, and drag, the work history collection module 1200 can collect relevant action log data.

Further, information that is included in log data is not limited only to those described above, and various items of information such as the name of an application program that is being executed or the name of a file that a user is working on may be included in log data.

The work history collection module 1200 can obtain image data in addition to event log data and action log data. Image data collected by the work history collection module 1200 may be classified as screen image data or action image data.

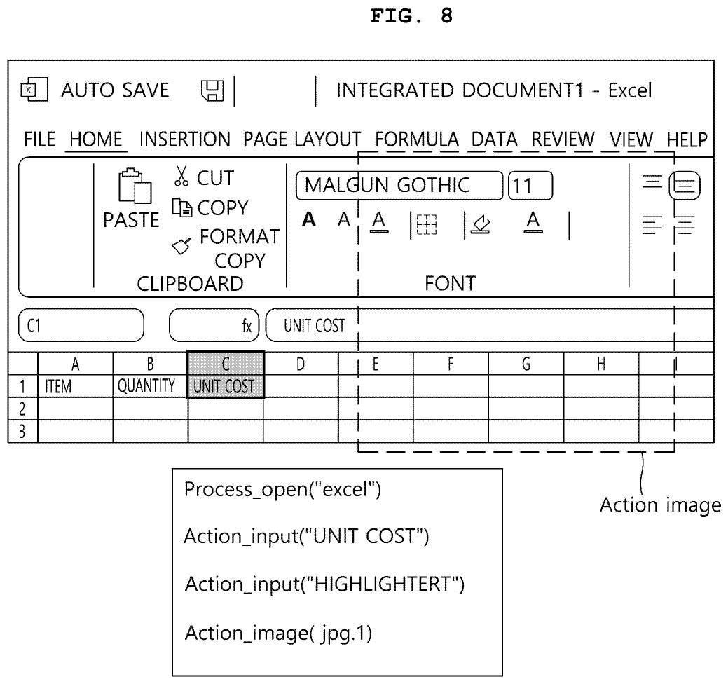

Referring to FIG. 8, the work history collection module 1200 can obtain action image data. For example, action image data may be obtained together when action log data is obtained, and may show an image of an action of the action log data obtained together. In detail, when a specific function is performed through a click action in an application program that is being executed in an electronic device, action image data ‘Actionimage(jpg.1)’ can be obtained together with ‘Action_input (“specific function”)’ that is action log data. In this case, the action image data, as shown in FIG. 8, may be data about an image having a predetermined size on the basis of the position, where the click action was performed, of images that are output by the electronic device.

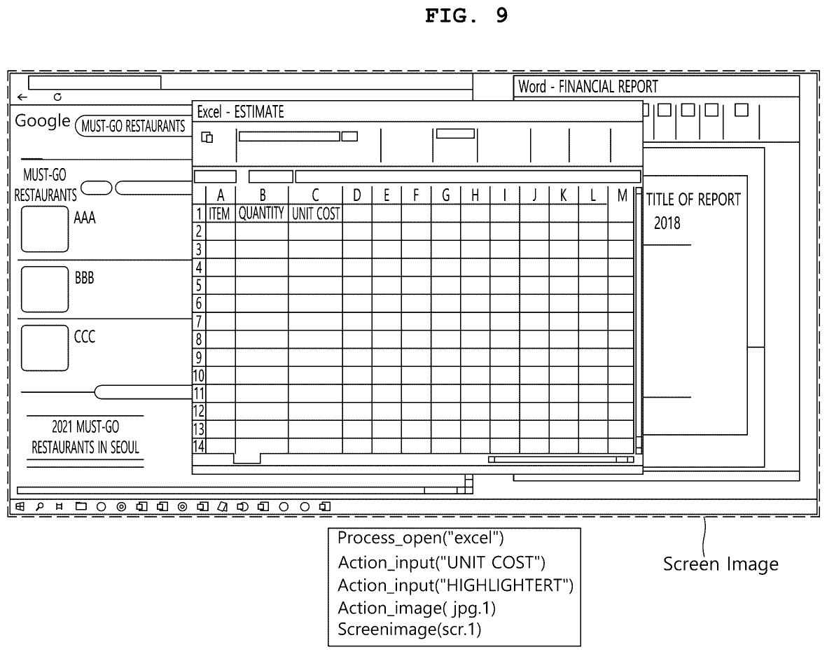

Referring to FIG. 9, the work history collection module 1200 can obtain screen image data. Screen image data may be data about an image having a relatively large size in comparison to an action image. For example, screen image data, as shown in FIG. 9, may be data about a screen shot image of the entire screen that is output by an electronic device. Screen image data can be obtained together when action log data is obtained. Further, screen image data can be obtained together when action image data is obtained. An image corresponding to action image data may be included in an image corresponding to screen image data.

Action image data and screen image data may be collected together with action log data when an action is generated, as described above, but they may be collected together with event log data when an event (e.g., execution or end of an application program, etc.) occurs and may be collected at regular periods regardless of log data.

Since action image data and screen image data are collected together, log data can be more clearly discriminated. For example, when a certain action is generated and only screen image data is correspondingly collected while a plurality of application programs is executed in an electronic device, it may not be clear what application program the action has been generated in. As another example, when a certain action is generated and only action image data is correspondingly collected while a plurality of application programs having similar backgrounds is executed in an electronic device, similarly, it may not be clear what application program the action has been generated in. In other words, in the task process analysis method, since action image data and screen image data are both collected as work history data, the accuracy of an analysis result can be improved.

Meanwhile, the work history data described through FIG. 5 and FIG. 9 is an example about certain log data or image data and the obtaining order or process is not limited to that shown in the figures.

### [Classification of Work History Data]

In task process analysis, the task process analysis model 1000 can classify work history data (S120). For example, the preprocessing module 1400 can classify work history data as a task or a non-task. Further, the preprocessing module 1400 can classify work history data classified as a task into a plurality of tasks in accordance with a preset reference.

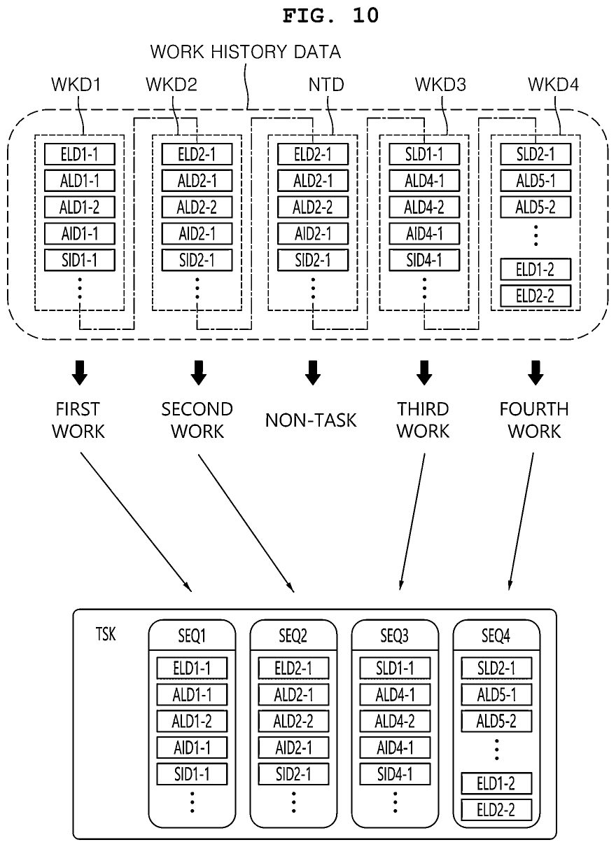

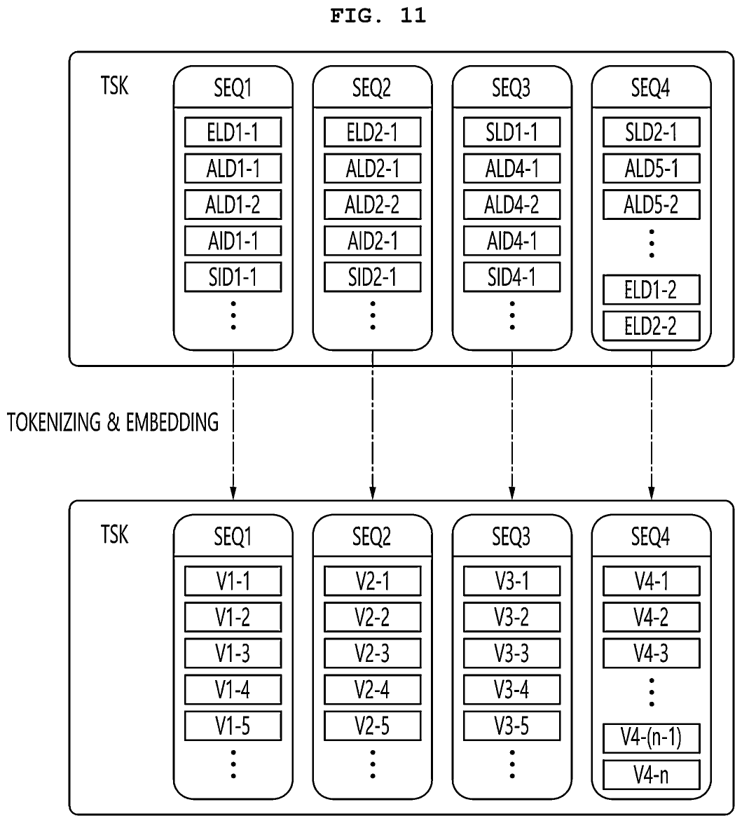

Hereafter, it is assumed that work history data include log data and image data for the convenience of description, as shown in FIG. 10, but the spirit of the present disclosure is not limited thereto.

It is assumed that when an individual, or the like conducts a task, the work history data shown in FIG. 10, in time series, uses a first application program relating to first work, uses a second application program relating to second work, uses again the first application program relating to third work, and then uses the second application program relating to fourth work.

In detail, work history data may include first work data WKD1, second work data WKD2, non-task data NTD, third work data WKD3, and fourth work data WKD4. In this case, the first to fourth work data WKD1, WKD2, WKD3, and WKD4 are data relating to first to fourth work, respectively and the non-task data NTD can be understood as data not relating to a task.

The first work data WKD1 may include 1-1 event log data ELD1-1, 1-1 action log data ALD1-1, 1-2 action log data ALD1-2, 1-1 action image data AID1-1, 1-1 screen image data SID1-1, etc. The first work data WKD1 can be understood as a set of data relating to execution and use of the first application program of work history data.

The second work data WKD2 may include 2-1 event log data ELD2-1, 2-1 action log data ALD2-1, 2-2 action log data ALD2-2, 2-1 action image data AID2-1, 2-1 screen image data SID2-1, etc. The second work data WKD2 can be understood as a set of data relating to execution and use of the second application program of work history data.

The non-task data NTD may include 3-1 event log data ELD3-1, 3-1 action log data ALD3-1, 3-2 action log data ALD3-2, 3-1 action image data AID3-1, 3-1 screen image data SID3-1, etc. The non-task data NTD can be understood as a set of data relating to execution and use of the third application program of work history data, and this case, the third application program may be a program that has no relevance or has very low relevance to a task.

The third work data WKD3 may include 1-1 switch log data SLD1-1, 4-1 action log data ALD4-1, 4-2 action log data ALD4-2, 4-1 action image data AID4-1, 4-1 screen image data SID4-1, etc. In this case, the switch log data may be data showing that a main program that is being executed has been switch to another program. For example, the 1-1 switch log data SLD1-1 may be data showing that a window has been switched to the first application program from the third application program. The third work data WKD3 can be understood as a set of data relating to the case in which the first application program of work history data is used again.

The fourth work data WKD4 may include 2-1 switch log data SLD2-1, 5-1 action log data ALD5-1, 5-2 action log data ALD5-2, 1-2 event log data ELD1-1, 2-2 event log data ELD2-2, etc. In this case, the 2-1 switch log data may be data showing that a window has been switched from the first application program to the second application program. Further, the 1-2 event log data ELD1-2 may show end of the first application program and the 2-2 event log data ELD2-2 may show end of the second application program. The fourth work data WKD4 can be understood as a set of data relating an action of ending the first and second application programs when the second application program of work history data is used again.

The preprocessing module 1400 can classify work history data a ‘task’, ‘non-task’, or ‘unknown’.

For example, the preprocessing module 1400 can classify work history data using an unsupervised learning algorithm. In detail, the preprocessing module 1400 can make a plurality of data groups by clustering work history data and can determine the category of each data group as task, non-task, unknown, or the like. In this case, a k-means algorithm, etc. may be used as the clustering algorithm, and a manual/automatic labeling or validation algorithm may be used for the method of determining categories.

As another example, the preprocessing module 1400 can classify work history data on the basis an application program that is executed. In detail, the preprocessing module 1400 can classify data until an application program having low relevance to a task (e.g., a personal messenger, the internet, a game, etc.) is executed after an application program having high relevance to a task (e.g., document editing tools such as Word or Power point) is executed as a task, and can classify data until switching to an application program having high relevance to a task after an application program having low relevance to a task as a non-task. In this case, application programs having high relevance to a task and application programs having low relevance to a task may be set in advance.

In this case, event log data and switch log data can be used as a reference for classifying the work history data.

Alternatively, a history data in which application programs that are being executed are recorded over time may be used as a reference for classifying the work history data. The work history data can be classified on the basis of a point in time at which an application program that is being executed is changed from an application program having high relevance to a task to an application program having low relevance to a task, or in the opposite case.

### [Creation of Sequence Data]

In task process analysis, the task process analysis model 1000 can create sequence data (S130). For example, the preprocessing module 1400 create at least one sequence data from data classified as a task in work history data.

The sequence data may mean a set of divided data when work history data is divided on the basis of a preset reference.

The preset reference is switching of an application program that is being executed, changing of a file that a user is working on, or the like, and the name of an application program that is being executed, the name of a file that a user is working on, event log data, and/or image data may be used as the preset reference.

For example, the preprocessing module 1400 can create sequence data using event log data. In detail, referring to FIG. 10, when the name of an application program included in the 1-1 even log data ELD1-1 of work history data and the name of an application program included in the 2-1 event log data ELD2-1 are different, the preprocessing module 1400 can define data before the 2-1 event log data ELD2-1 from after the 1-1 event log data ELD1-1 as first sequence data SEQ1.

As another example, the preprocessing module 1400 can create sequence data using a file name. In detail, when the name of a file that a user is working on is changed, the preprocessing module 1400 classify data before and after the point in time of changing (or log data corresponding to the point in time of changing) as sequence data different from each other. In this case, the file name may be included in log data or may be separately collected by the work history collection module 1200.

As another example, the preprocessing module 1400 can create sequence data using the name of an application program that is being executed. In detail, when the name of an application program that is being executed is changed, the preprocessing module 1400 classifies data before and after the point in time of changing (or log data corresponding to the point in time of changing) as sequence data different from each other. In this case, the name of an application program that is being executed may be included in log data or may be separately collected by the work history collection module 1200.

The preprocessing module 1400 can create sequence data using at least two or more of the event log data described above, the name of an application program that is being executed, or the name of a file that a user is working on.

Meanwhile, the preprocessing module 1400 may further consider image data to create sequence data. For example, the preprocessing module 1400 can sense switch of action image data and/or variation of screen image data, and can classify sequence data on the basis of the sensed variation when the variation is a preset level or more. In this case, an image processing technology can be used as the method of sensing variation of image data.

Meanwhile, the created sequence data can constitute reference task data TSK. Referring to FIG. 10, first to fourth sequence data SEQ1, SEQ2, SEQ3, and SEQ4 created from work history data can constitute one reference task data TSK. The reference task data can be input to the task prediction module 1600 to be described below. In this case, the sequence data may mean unit data that is input to the task prediction module 1600 and the number of input nodes included in the task prediction module 1600 may correspond to or may be larger than the total number of sequence data included in the reference task data TSK.

Further, the case in which four sequence data are created from work history data was described above, but the spirit of the present disclosure is not limited thereto and it should be noted that the number of sequence data may be changed, depending on the number of work and the reference for classifying sequences.

### [Tokenizing & Embedding]

In task process analysis, the task process analysis model 1000 can tokenize data (S140). The preprocessing module 1400 can create at least one or more token data by tokenizing log data included in sequence data.

Tokenization may be performed in various ways such as character-level tokenization, word-level tokenization, or sentence-level tokenization. For example, the preprocessing module 1400 can create token data of ‘Process_open’, ‘ (’, ‘”’, ‘application program name’, ‘“’, ‘)’ by tokenizing log data of ‘Process_open (“application program name”)’. As another example, the preprocessing module 1400 can create token data of ‘LOG_PROCESS_OPEN_application program name’ by tokenizing log data of ‘Process_open (“application program name”)’.

Meanwhile, at least some data of data included in sequence data may not be tokenized. For example, image data of sequence data may not be tokenized.

In task process analysis, the task process analysis model 1000 can embed data (S150). The preprocessing module 1400 can create at least one vector data by embedding data included in sequence data. In this case, the vector data may mean data expressing a natural language, an image, or the like in an n-dimensional data format (n is a natural number).

The preprocessing module 1400 can create log vector data by embedding token data obtained by tokenizing log data included in sequence data. In this case, a work embedding technique can be used, and for example, Latent Semantic Analysis (LSA), Word2Vec, FastText, Global Vectors for Word Representation (GloVe), etc. may be used.

The preprocessing module 1400 can create image vector data by embedding image data included in sequence data. In this case, an image embedding technique can be used, and for example, a feature extraction technique using a convolution layer may be used.

Referring to FIG. 11, log data and image data included in reference task data TSK all changed into vector data through tokenizing and/or embedding. The reference task data TSK including vector data shown in FIG. 11 can be input to the task prediction module 1600 to be described below.

Meanwhile, the orders of the steps S120 and S150 described above may be switched. For example, the preprocessing module 1400 may perform first tokenizing and/or embedding on work history data, select data relating to a task from the data, and create sequence data using the selected data. As another example, the preprocessing module 1400 may select data relating to a task from work history data, perform tokenizing and/or embedding on the selected data, and create sequence data using the vectorized data.

### [Task Prediction Process]

In task process analysis, the task process analysis model 1000 can create output data using the task prediction module 1600 (S160).

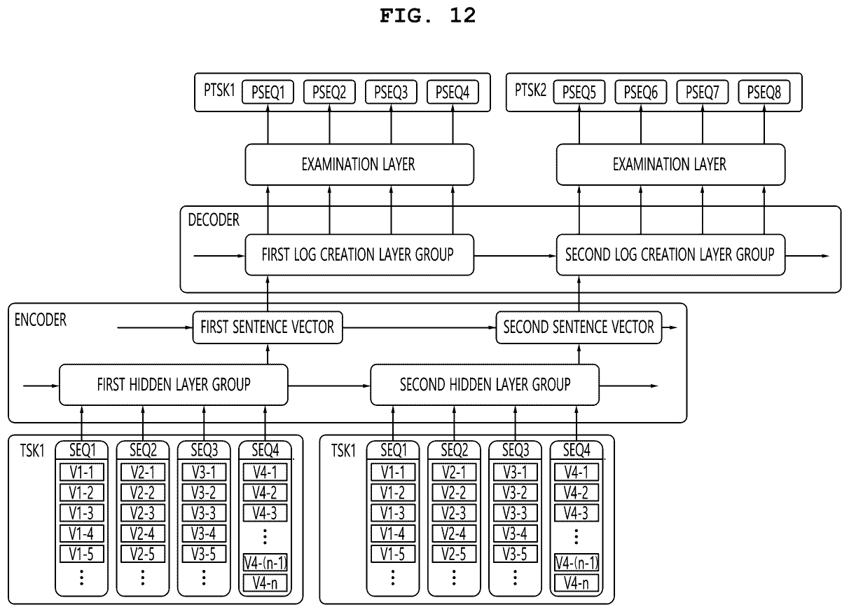

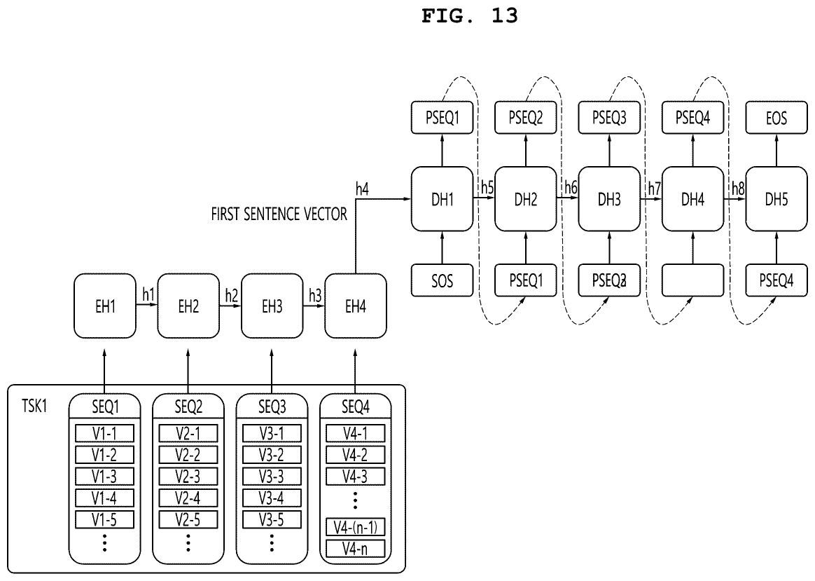

Hereafter, the structure of the task prediction module 1600 is described with reference to FIG. 12 and FIG. 13. In this case, it is assumed that the task prediction module 1600 is implemented as a sequence-to-sequence model for the convenience of description, but the spirit of the present disclosure is not limited thereto and the task prediction module 1600 may be implemented as not only a learning model that is used to natural language processing, but a deep learning model that processes time-series data.

Referring to FIG. 12, the task prediction module 1600 may include an encoder and a decoder.

The encoder can receive reference task data TSK. The encoder may include at least one hidden layer for receiving reference task data TSK. The encoder may include hidden layers over the number of sequence data included in reference task data TSK. In this case, hidden layers for receiving one reference task data TSK may be classified into one hidden layer group. For example, referring to FIG. 12 and FIG. 13, when first reference task data TSK including first to fourth sequence data SEQ1, SEQ2, SEQ3, and SEQ4 is input, the encoder may include a first hidden layer group that receives the first reference task data TSK and the first hidden layer group may include first to fourth encoder hidden layers EH1, EH2, EH3, and EH4.

The encoder can output a sentence vector by receiving reference task data TSK. A sentence vector can be understood as data having the property of the reference task data TSK that is input tot eh encoder. A sentence vector can be used to create prediction task data in the decoder, as will be described below. A sentence vector can be understood as a concept corresponding to a context vector in a common sequence-to-sequence model. However, a sentence vector does not have a specific data format and may mean intermediate vector that may have a certain data format that is transmitted to the decoder from the encoder.

In more detail, the decoder includes at least one encoder hidden layer and each of the encoder hidden layers can output a hidden state by receiving at least sequence data. Referring to FIG. 13, a first encoder hidden layer EH1 of the encoder can output a first hidden state h1 by receiving first sequence data SEQ1 of reference task data TSK, and can provide the first hidden state h1 to a second encoder hidden layer EH2. Similarly, the second encoder hidden layer EH2 can output a second hidden state h2 by receiving second sequence data SEQ2 and the first hidden state h1 and provide the second hidden state h2 to a third encoder hidden layer EH3, and the third encoder hidden layer EH3 can output a third hidden state h3 by receiving third sequence data SEQ3 and the second hidden state h2 and provide the third hidden state h3 to a fourth encoder hidden layer EH4. The fourth encoder hidden layer EH4 that is the last hidden layer can output a fourth hidden state h4 by receiving fourth sequence data SEQ4 and the third hidden state h3, and a first sentence vector can be created from the fourth hidden state h4.

The hidden layer included in the encoder may be implemented as a Recurrent Neural Network (RNN) model, a Long-Short Term Memory (LSTM) model, or a Gated Recurrent Unit (GRU) model.

Meanwhile, an attention technique can be used to create a sentence vector. For example, a sentence vector that is created by the encoder can be calculated using a plurality of hidden states, which is output from the hidden layers in the encoder, and a weight for each of the hidden states rather than created from a hidden state that is output from the last encoder hidden layer in the encoder.

The decoder can output prediction task data. The decoder may include at least one log creation layer that outputs prediction task data. The number of log creation layers included in the decoder may be equal to or larger than the number of sequence data included in reference task data TSK. Alternatively, the number of log creation layers included in the decoder may be equal to or larger than the number of hidden layers included in the encoder. In this case, log creation layers for outputting one prediction task data can be classified into one log creation layer group. For example, referring to FIG. 12 and FIG. 13, when the decoder output first prediction task data PTSK1 corresponding to first reference task data TSK1, the decoder may include a first log creation layer group that outputs first to fourth prediction sequence data PSEQ1, PSEQ2, PSEQ3, and PSEQ4 included in the first prediction task data PTSK1. In this case, the first log creation layer group may include first to fourth decoder hidden layers DH1, DH2, DH3, and DH4 that output first to fourth prediction sequence data PSEQ1, PSEQ2, PSEQ3, and PSEQ4, respectively.

The hidden layer included in the decoder may be implemented as an RNN model, an LSTM model, or a GRU model. The hidden layer included in the decoder may be implemented as the same model of the hidden layer included in the encoder. Alternatively, the hidden layer included in the decoder may be implemented as a different model from the hidden layer included in the encoder.

The decoder can be provided with a sentence vector from the encoder. The decoder can output prediction task data using the sentence vector. For example, referring to FIG. 13, a first decoder hidden layer DH1 can create first prediction sequence data PSEQ1 and a fifth hidden sate h5 by receiving a first sentence vector and start data SOS and provide the first prediction sequence data PSEQ1 and the fifth hidden sate h5 to a second decoder hidden layer DH2, and the second decoder hidden layer DH2 can create second prediction sequence data PSEQ2 and a sixth hidden sate h6 by receiving the first prediction sequence data PSEQ1 and the fifth hidden sate h5 and provide the second prediction sequence data PSEQ2 and the sixth hidden sate h6 to a third decoder hidden layer DH3. Similarly, the third decoder hidden layer DH3 can output third prediction sequence data PSEQ3, the fourth decoder hidden layer DH4 can output fourth prediction sequence data PSEQ4, and the decoder can repeatedly output prediction sequence data until end data SOS is output.

Prediction sequence data that is output from the decoder may be the same form as sequence data that is input to the encoder. For example, sequence data may include a plurality of prediction vector data and each of the prediction vector data may be converted into prediction log data or prediction image data.

Alternatively, prediction sequence data that is output from the decoder may include prediction log data and/or prediction image data. In this case, specific conversion may not be required.

The data form included in prediction sequence data that is output from the decoder may be changed, depending on the training method for the task prediction module 1600 to be described below.

The task prediction module 1600 can sequentially receive a plurality of reference task data TSK.

For example, referring to FIG. 12, the first reference task data TSK including first to fourth sequence data SEQ1, SEQ2, SEQ3, and SEQ4 is input to the first hidden layer group of the encoder, whereby a first sentence vector can be created. Further, second reference task data TSK including fifth to eighth sequence data SEQ5, SEQ6, SEQ7, and SEQ8 is input to the second hidden layer group of the encoder, whereby a second sentence vector can be created. In this case, a hidden state can be provided from the first hidden layer group to the second hidden layer group, and the second sentence vector can be created using the first sentence vector. The decoder may include a first log creation layer group that creates first prediction task data PTSK1 by receiving the first sentence vector and a second log creation layer group that creates second prediction task data PTSK2 by receiving the second sentence vector. In this case, a hidden state can be provided from the first log creation layer group to the second log creation layer group.

In this case, the second reference task data TSK2 can be created from work history data collected by the work history collection module 1200.

Alternatively, the second reference task data TSK2 may be prediction task data created by the task prediction module 1600 using the first reference task data TSK1. In this case, the entire task process can be predicted from even only start task data of the entire task process.

Prediction task data that is output from the decoder can be examined by the examination module 1800. For example, referring to FIG. 12, prediction task data that is output from the decoder can be examined through an examination layer included in the examination module 1800. The method of examining prediction task data by means of the examination module 1800 will be described below.

Meanwhile, the case in which data that is input to an encoder is reference task data including at least one sequence data was described above, but the spirit of the present disclosure is not limited thereto and the form or the matter of data that is input to an encoder may be changed, depending a training for method the task prediction module 1600.

### [Data Examination]

In task process analysis, the task process analysis model 1000 can examine output data (S170). The data examination operation to be described hereafter can be understood as a process of checking whether prediction data that is output from the task prediction module 1600 has a correct form. Since this examination process is performed, the final product that is created in task process analysis can have a more accurate form, and task prediction or analysis using the final product can also be more easily performed.

The examination module 1800 can examine output data obtained from the task prediction module 1600. In this case, the output data means data output from the task prediction module 1600 and can be understood as a concept generally including the prediction task data, prediction sequence data, prediction log data, prediction image data, or the like described above.

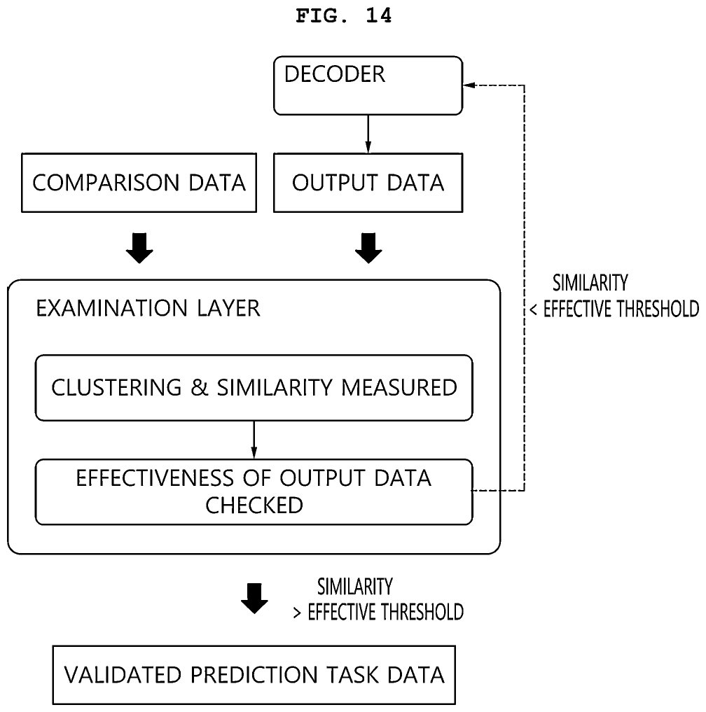

FIG. 14 is a diagram showing an examination operation that is performed by the examination module 1800 according to an embodiment of the present disclosure.

Referring to FIG. 14, the examination module 1800 may include an examination layer. The examination layer can output validated prediction task data by receiving comparison data and output data.

The comparison data may mean data having a data form that prediction task data is supposed to have. For example, the comparison data may include certain log data, certain image data, certain log vector data, certain image vector data, certain sequence data, certain work history data, etc. In this case, the comparison data may be real data the same as collected work history data, fake data made in a similar form to real data, or a combination thereof. In detail, the comparison data may include work history data collected by the work history collection module 1200 and used for task process analysis, work history data collected or received separately from the above work history data, or newly created work history data.

The examination module 1800 can measure similarity of comparison data and output data.

For example, the examination module 1800 can individually compare comparison data and output data. In detail, the examination module 1800 can measure similarity by individually comparing log data, image data, or vector data thereof of output data with comparison data such as certain log data or vector data thereof, or certain image data or vector data thereof. In this case, the examination module 1800 can use an algorithm such as cosine similarity, Euclidean Distance, a k-means algorithm, Jaccard Similarity, or Dynamic Time Warping (DTW).

As another example, the examination module 1800 can generally compare comparison data and output data. In detail, the examination module 1800 can measure similarity by comparing clustering data clustering output data into a plurality of groups with certain clustering data clustering comparison data into a plurality of groups or comparing sequence data of output data with certain sequence data. In this case, the examination module 1800 can use an algorithm such as cosine similarity, Euclidean Distance, a k-means algorithm, Jaccard Similarity, or Dynamic Time Warping (DTW).

The examination module 1800 can check effectiveness of the output data on the basis of the measured similarity. For example, the examination module 1800 can determine that comparison data and output data are similar when the measured similarity is an effective threshold or more, and can determine that comparison data and output data are not similar when the measured similarity is an effective threshold or less.

When determining that output data is effective, the examination module 1800 can create validated prediction task data using the output data. In this case, the validated prediction task data may be the same as the output data or may be created by processing the output data.

When determining that the output data is not effective, the task prediction module 1600 can create output data again. In this case, the output data that is created again can be created by the method described above and can be understood as secondary prediction task data including at least secondary prediction sequence data. The examination module 1800 can perform the examination process using the secondary prediction task data and the comparison data. The examination module 1800 can perform examination until determining that data that is output from the task prediction module 1800 is effective.

Meanwhile, the step of examination by the examination module 1800 (S170) may be omitted. For example, data that is output from the task prediction module 1600 may be final prediction task data.

In task process analysis, the task process analysis model 1000 can provide information about a next task (S180). For example, the task process analysis model 1000 can provide information about a next task using prediction task data or validated prediction task data. In this case, the next task may mean a task that should be performed after a reference task corresponding to work history data used in task process analysis or reference task data TSK. In detail, the task process analysis model 1000 can create a work list using log data or image data included in predict task data or validated prediction task data, and can provide the created work list. The task process analysis model 1000 may include an information providing module (not shown) for the information providing step (S180).

### [Training Method]

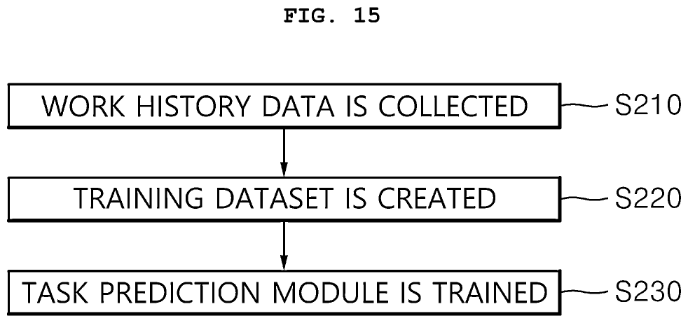

FIG. 15 is a diagram showing a training method for the task prediction module 1800 according to an embodiment of the present disclosure. Referring to FIG. 15, the training method may include a step of collecting work history data (S210), a step of creating a training dataset (S220), and a step of training the task prediction module 1600 (S230). The training method can be performed by a training module (not shown) included in the task process analysis model 1000 or separately configured.

Hereafter, these steps are described in detail.

Work history data can be collected to train the task prediction module 1600 (S210). The process of collecting work history data is the same as that of the work history collection module 1200 described above, so detailed description thereof is omitted.

Meanwhile, the work history data for training may mean work history data that is obtained while an individual, or the like perform the entire task process. Accordingly, when the entire task process includes first to k-th work (k is a natural number of 2 or more), the work history data for training may include log data and image data that relate to the first to k-th work.

Further, the work history data for training may include also randomly created data other than data collected in accordance with actual task performance.

A training dataset can be created to train the task prediction module 1600 (S220). The training dataset can be created using the work history data collected in step S210. The training dataset may mean data obtained by labeling data that is input to the task prediction module 1600 with data that should be output from the task prediction module 1600 in the task process analysis method.

For example, when the task prediction module 1600 includes an encoder and a decoder, a training dataset can be created by labeling at least one sequence data, which is created using data relating to a first task of work history data for training, with at least one sequence data created using data relating to a second task that the next order of the first task of work history data for training.

As another example, a training dataset can be created by labeling log data and/or image data relating to the first task of work history data for training with log data and/or image data relating to the second task that is the next order of the first task of the work history data for training.

The task prediction module 1600 can be trained using the training dataset (S230). The task prediction module 1600 can be trained using a teacher forcing method. For example, when the task prediction module 1600 includes an encoder and a decoder, at least sequence data relating to first work of the dataset for training described above is input to the encoder, an error value is calculated by comparing a value that is output from the decoder and data labeled to the data that is input to the encoder (e.g., at least one sequence data relating to second work that is the next order of the first work of the dataset for training described above), and weight values of layers in the encoder and the decoder can be corrected using the error. The features, structures, effects, etc. described in embodiments are included in at least one the above embodiment of the present disclosure, but are not necessarily limited to only one embodiment. Further, the features, structures, effects, etc. exemplified in each embodiment may be combined or modified also in other embodiments by those skilled in the art to which the embodiment are pertained. Accordingly, configurations related to the combinations and modifications should be construed as being included in the range of the present disclosure.

Although the present disclosure was described above with reference to embodiments, the embodiments are only examples and do not limit the spirit of the present disclosure, and those skilled in the art would know that the present disclosure may be changed and modified in various ways not exemplified above without departing from the scope of the present disclosure. That: is, the components described in detail in the embodiments of the present disclosure may be modified. Further, differences relating to the changes and modifications should be construed as being included in the scope of the present disclosure which is determined by claims.

What is claimed is:

1. A task prediction method that is performed in an electronic device of a user, the task prediction method comprising:
obtaining operation history data according to use of the electronic device of the user—the operation history data including a plurality of log data and a plurality of image data;
obtaining reference task data using the operation history data—the reference task data including at least one sequence data and the sequence data being created using at least some of the plurality of log data and at least some of the plurality of image data; and
obtaining forecast task data using the reference task data and a task forecast module,
wherein the task forecast module includes an encoder that outputs intermediate data by receiving the reference task data, and a decoder that obtains the intermediate data from the encoder and outputs data using the intermediate data,
wherein the encoder includes neural networks of the number corresponding to the number of sequence data included in the reference task data.

2. The task prediction method of claim 1, wherein the plurality of log data is classified as event log data corresponding to execution of application programs stored at least in the electronic device or action log data corresponding to specific function performance in the application programs.

3. The task prediction method of claim 2, wherein the plurality of image data is classified as action image data relating to at least the specific function performance or screen image data relating to the specific function performance,
the action image data is data relating to at least some of images that are output through a screen of the electronic device,
the screen image data is data relating to at least some of images that are output through the screen of the electronic device, and
the size of an image corresponding to the screen image data is larger than the size of an image corresponding to the action image data.

4. The task prediction method of claim 1, wherein the obtaining of reference task data includes:
classifying the plurality of log data and the plurality of image data at least into a task group or a non-task group; and
creating the at least one sequence data using log data and image data classified as the task group.

5. The task prediction method of claim 1, wherein the obtaining of reference task data includes creating the sequence data by classifying the plurality of log data and the plurality of image data on the basis of at least one event log data, and
the event log data that is one of the plurality of log data corresponds to execution or end of an application program stored in the electronic device.

6. The task prediction method of claim 1, wherein the sequence data includes at least one log vector data obtained by processing at least some of the plurality of log data and at least one image vector data obtained by processing at least some of the plurality of image data.

7. The task prediction method of claim 1, wherein the obtaining of reference task data includes:
obtaining at least one tokenized log data by tokenizing at least some of the plurality of log data; and
obtaining log vector data by embedding the tokenized log data.

8. The task prediction method of claim 1, wherein the task prediction module is a sequence-to-sequence module and the intermediate data is vector data obtained from the at least one sequence data of the reference task data.

9. The task prediction method of claim 1, wherein the neural network is a recurrent neural network model.

10. The task prediction method of claim 1, wherein the neural network model is a Long-Short Term Memory (LSTM) model.

11. The task prediction method of claim 1, wherein the obtaining of prediction task data include:
creating at least one prediction sequence data by inputting the intermediate data and start data into the decoder; and
creating the prediction task data using the at least one prediction sequence data, and
the prediction sequence data includes at least one prediction log data.

12. The task prediction method of claim 1, further comprising examining the prediction task data.

13. The task prediction method of claim 12, wherein the prediction task data includes at least one primary prediction sequence data—the primary prediction sequence data including at least one prediction log data, and
the examining of prediction task data includes comparing the at least one prediction log data of the primary prediction sequence data with at least one certain log data.

14. The task prediction method of claim 13, wherein the comparing of the at least one prediction log data with at least one certain log data includes calculating similarity between the at least one prediction log data with the at least one certain log data using a Dynamic Time Warping (DTW) algorithm.

15. The task prediction method of claim 14, comprising
creating at least one secondary prediction sequence data using the task prediction module when the similarity is a preset effective threshold or less, or
creating prediction task data validated using the at least one primary prediction sequence data when the similarity is a preset effective threshold or more.

16. The task prediction method of claim 11, wherein the at least one certain log data is a portion of the plurality of log data.

17. The task prediction method of claim 1, further comprising
displaying information about a next task, which should be performed after a task corresponding to the reference task data, on the electronic device on the basis of the prediction task data.

18. A task flow analysis model that is stored in a computer-readable recording medium, the task flow analysis model comprising:
a work history collection module that obtains work history data corresponding to work performed through the electronic device—the work history data including a plurality of log data and a plurality of image data;
a preprocessing module that obtains reference task data by processing the work history data—the reference task data including at least one sequence data and the sequence data being created using at least some of the plurality of log data and at least some of the plurality of image data; and
a task prediction module that obtains prediction task data using at least the reference task data,
wherein the task prediction module includes an encoder that outputs intermediate data by receiving the reference task data, and a decoder that obtains the intermediate data from the encoder and outputs data using the intermediate data, and
the encoder includes neural networks of the number corresponding to the number of sequence data included in the reference task data.

19. An electronic device-readable task flow analysis model, the task flow analysis model comprising:
a work history collection module that obtains work history data corresponding to work performed through the electronic device—the work history data including a plurality of log data and a plurality of image data;
a preprocessing module that obtains reference task data by processing the work history data—the reference task data including at least one sequence data and the sequence data being created using at least some of the plurality of log data and at least some of the plurality of image data; and
a task prediction module that obtains prediction task data using at least the reference task data,
wherein the task prediction module includes an encoder that outputs intermediate data by receiving the reference task data, and a decoder that obtains the intermediate data from the encoder and outputs data using the intermediate data, and
the encoder includes neural networks of the number corresponding to the number of sequence data included in the reference task data.
